(19) United States
(12) Patent Application Publication
(10) Pub. No.: US 2026/0309872 A1
(43) Pub. Date: Oct. 8, 2026

(54) SATELLITE POSITIONING SYSTEM SPOOFING MITIGATION

(71) Applicant: QUALCOMM Incorporated, San Diego, CA (US)

(72) Inventors: Raghavender KASTURI, Hyderabad (IN); Mutyala Rao NEELAPALA, Rajahmundry (IN); Navaneeth Krishnan UNNIKRISHNAN NAIR, Kottarakkara (IN); Vaseem SYED, Khammam (IN); Rajasekhar Reddy CHENCHALA, Nellore (IN); Subramanyam NALLI, Hyderabad (IN)

(21) Appl. No.: 19/169,083

(22) Filed: Apr. 3, 2025

(51) Int. Cl. G01S 19/21; H04L 41/16; H04W 24/10; H04W 64/00

(52) U.S. Cl. CPC G01S 19/21; H04L 41/16; H04W 24/10; H04W 64/00

(57) ABSTRACT

A method of processing positioning signals includes: measuring a first plurality of positioning signals to determine active measurements; determining, based on the active measurements, a first conformance indicator; determining, based on the first conformance indicator and a second conformance indicator, whether any of the first plurality of positioning signals is spoofed, the second conformance indicator being indicative of how well previous measurements of a second plurality of positioning signals, made before the active measurements of the first plurality of positioning signals, corresponded to previously-expected measurements of the second plurality of positioning signals; and determining position information of the mobile device using the active measurements of the first plurality of positioning signals other than any of the active measurements corresponding to a respective one of the first plurality of positioning signals determined to be spoofed.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc., with a sixth-generation (6G) service in development. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

Positions of devices, such as mobile devices, may be determined using terrestrial-based positioning signals (e.g., 5G, 6G and/or satellite positioning signals. Satellite positioning system receivers may be included in various devices for receiving and measuring satellite positioning signals. Measurements of the satellite positioning signals may be processed to determine position information, such as ranges between satellites and the receiver and/or a position estimate for the receiver.

### SUMMARY

An example mobile device includes: at least one receiver configured to receive a first plurality of positioning signals and a second plurality of positioning signals; at least one memory; and at least one processor communicatively coupled to the at least one receiver and the at least one memory and configured to: measure the first plurality of positioning signals to determine active measurements of the first plurality of positioning signals; determine, based on the active measurements, a first conformance indicator that is indicative of how well the active measurements correspond to expected measurements of the first plurality of positioning signals; determine, based on the first conformance indicator and a second conformance indicator, whether any of the first plurality of positioning signals is spoofed, the second conformance indicator being indicative of how well previous measurements of a second plurality of positioning signals, made before the active measurements of the first plurality of positioning signals, corresponded to previously-expected measurements of the second plurality of positioning signals; and determine position information of the mobile device using the active measurements of the first plurality of positioning signals other than any of the active measurements corresponding to a respective one of the first plurality of positioning signals determined to be spoofed.

An example method of processing positioning signals includes: measuring a first plurality of positioning signals to determine active measurements; determining, based on the active measurements, a first conformance indicator; determining, based on the first conformance indicator and a second conformance indicator, whether any of the first plurality of positioning signals is spoofed, the second conformance indicator being indicative of how well previous measurements of a second plurality of positioning signals, made before the active measurements of the first plurality of positioning signals, corresponded to previously-expected measurements of the second plurality of positioning signals; and determining position information of the mobile device using the active measurements of the first plurality of positioning signals other than any of the active measurements corresponding to a respective one of the first plurality of positioning signals determined to be spoofed.

Another example mobile device includes: means for measuring a first plurality of positioning signals to determine active measurements of the first plurality of positioning signals; means for determining, based on the active measurements, a first conformance indicator that is indicative of how well the active measurements correspond to expected measurements of the first plurality of positioning signals; means for determining, based on the first conformance indicator and a second conformance indicator, whether any of the first plurality of positioning signals is spoofed, the second conformance indicator being indicative of how well previous measurements of a second plurality of positioning signals, made before the active measurements of the first plurality of positioning signals, corresponded to previously-expected measurements of the second plurality of positioning signals; and means for determining position information of the mobile device using the active measurements of the first plurality of positioning signals other than any of the active measurements corresponding to a respective one of the first plurality of positioning signals determined to be spoofed.

An example non-transitory, processor-readable storage medium includes processor-readable instructions to cause at least one processor of a mobile device, processing positioning signals, to: measure a first plurality of positioning signals to determine active measurements of the first plurality of positioning signals; determine, based on the active measurements, a first conformance indicator that is indicative of how well the active measurements correspond to expected measurements of the first plurality of positioning signals; determine, based on the first conformance indicator and a second conformance indicator, whether any of the first plurality of positioning signals is spoofed, the second conformance indicator being indicative of how well previous measurements of a second plurality of positioning signals, made before the active measurements of the first plurality of positioning signals, corresponded to previously-expected measurements of the second plurality of positioning signals; and determine position information of the mobile device using the active measurements of the first plurality of positioning signals other than any of the active measurements corresponding to a respective one of the first plurality of positioning signals determined to be spoofed.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a simplified diagram of a navigation environment.

FIG. 4 is a block diagram of an example user equipment.

FIG. 5 is a block diagram of a portion of the user equipment shown in FIG. 4.

FIG. 6 is an example of a conformity index database.

FIG. 7 is a block diagram of a set of components of the user equipment shown in FIG. 4.

FIG. 8 is an example of an isolated forest tree.

FIG. 9 is a block diagram of a spoofed positioning signal mitigation method.

FIG. 10 is a block diagram of components and an output of the user equipment shown in FIG. 4.

FIG. 11 is a block flow diagram of method of processing positioning signals.

### DETAILED DESCRIPTION

Techniques are discussed herein for mitigating consequences of spoofed positioning signals. For example, a machine learning algorithm, such as an unsupervised isolated forest algorithm, may be used to evaluate present and historical conformance of positioning inputs to detect spoofed signals. Any identified spoofed signal may be de-weighted or ignored in determining a position estimate of a mobile device, or a position estimate of the mobile device based on the spoofed signal(s) may be ignored. As another example, techniques are discussed for mitigating GNSS (Global Navigation Satellite System) spoofing by utilizing an unsupervised machine learning algorithm called Isolated Forest to generate a conformity index from GNSS signal parameters, enhancing the accuracy and reliability of GNSS-dependent systems by detecting inconsistencies and potential spoofing attacks, e.g., without requiring significant investment in additional hardware. These are example implementations, and other implementations may be used.

Items and/or techniques described herein may provide one or more of the following capabilities, as well as other capabilities not mentioned. Accuracy and/or reliability of position estimates, e.g., based on satellite positioning signal (SPS) measurements, may be improved. Spoofed positioning signals, e.g., SPS signals, may be more accurately identified. The risk of using incorrect position information to determine a position fix for a mobile device may be reduced. Legitimate/authentic and spoofed positioning signals may be distinguished, e.g., without significant (or possibly any) additional hardware or changes relative to existing satellite positioning systems of mobile devices. Observed positioning signal measurements may be simply, swiftly, and effectively identified as valid or invalid. Security of position fixes may be enhanced. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. In industrial applications, the location of a mobile device may be necessary for asset tracking, robotic control, and other kinematic operations which may require a precise location of an end effector. Existing positioning methods include methods based on measuring radio signals transmitted from a variety of devices or entities including satellite vehicles (SVs) and terrestrial radio sources in a wireless network such as base stations and access points. Stations in a wireless network may be configured to transmit reference signals to enable mobile device to perform positioning measurements. Various positioning methods for a UE are currently defined which can utilize reference signals transmitted by base stations in 4G LTE or 5G NR wireless networks such as Positioning Reference Signals (PRS) and/or Cell-specific Reference Signals (CRS) for position determination.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, automobile, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” a “device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® short-range wireless communication technology networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a gNodeB (gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

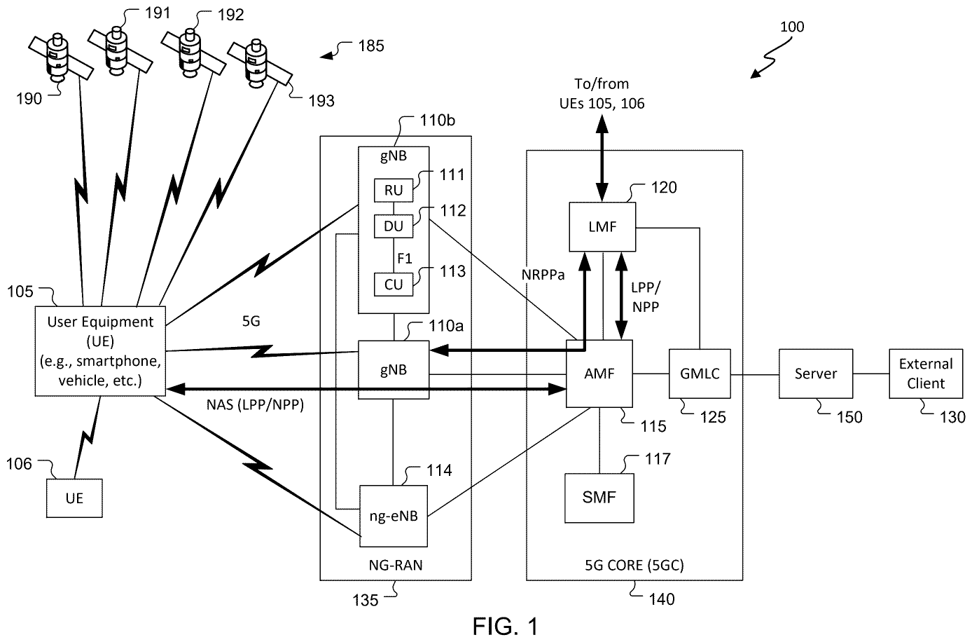

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., a smartphone, an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC has been performed by the Third Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, a future 6G RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193, also referred to as satellites or space vehicles, for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (referred to as gNodeBs or gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media and data sessions with UEs 105 and 106. Base stations such as the gNBs 110a, 110b and/or the ng-eNB 114 may each support a macro cell (e.g., a high-power cellular base station), or a small cell (e.g., a low-power cellular base station). There may also be access points (not shown in FIG. 1) that may each be a short-range base station configured to communicate with short-range technology such as WiFi® short-range wireless communication technology, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may be replaced by or include various other location server functionality and/or base station functionality respectively.

The system 100 is capable of wireless communication in that components of the system 100 can communicate with one another (at least sometimes using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geodetically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geodetically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect with one or more others UEs (e.g., the UE 106) via one or more device-to-device (D2D) or peer-to-peer (P2P) links, also referred to as sidelink links. The D2D, P2P and sidelink links may be supported with any appropriate sidelink radio access technology (RAT), such as LTE, LTE Direct (LTE-D), NR, WiFi® Direct (WiFi®-D), Bluetooth®, and so on. One or more of a group of UEs utilizing sidelink communication may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via sidelink communications may utilize a one-to-many (1:M) system in which each UE may transmit to other UEs in the group. A TRP may facilitate scheduling of resources for sidelink communications. In other cases, sidelink communication may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may correspond to (e.g., may be supported by) a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA), Downlink (DL) Time Difference of Arrival (TDOA), Uplink (UL) TDOA, Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push a location estimate of the UE 105 to the server 150. In some embodiments, the server 150 may be absent and the external client 130 may interact directly with the GMLC 125 to request and/or receive a location estimate for the UE 105.

The GMLC 125 may support a location request for the UE 105 received from the external client 130 either directly or via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 either directly or via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NRPPa), which may be defined in 3GPP Technical Specification (TS) 38.455. NRPPa messages can be transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 37.355. Here, LPP messages may be transferred between the UE 105 and the LMF 120 via the AMF 115 and the serving gNB 110a, 110b or the serving ng-eNB 114 for the UE 105. For example, LPP messages may be transferred between the LMF 120 and the AMF 115 using service operations based on the Hypertext Transfer Protocol (HTTP), and may be transferred between the AMF 115 and the UE 105 using a 5G Non-Access Stratum (NAS) protocol. The LPP protocol may be used to support positioning of the UE 105 using UE-assisted and/or UE-based position methods such as A-GNSS, RTK, OTDOA, DL-TDOA, AoD and/or E-CID. The NRPPa protocol may be used to support positioning of the UE 105 using network-based position methods such as UL-TDOA or E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP message via the NG-RAN 135 and the 5GC 140.

An LPP message sent from the LMF 120 to the UE 105 may instruct the UE 105 to do any of a variety of things depending on desired functionality. For example, the LPP message could contain an instruction for the UE 105 to obtain measurements for GNSS (or A-GNSS), WLAN, E-CID, OTDOA, DL-TDOA and/or AoD (or some other position method). In the case of E-CID, the LPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such implementations, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some examples, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use an LPP annex (LPPa) protocol (e.g., defined in 3GPP TS 36.455) in place of NRPPa to send and receive location information to and from the eNBs in the E-UTRAN and may use LPP to support positioning of the UE 105. In these other examples, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some examples, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

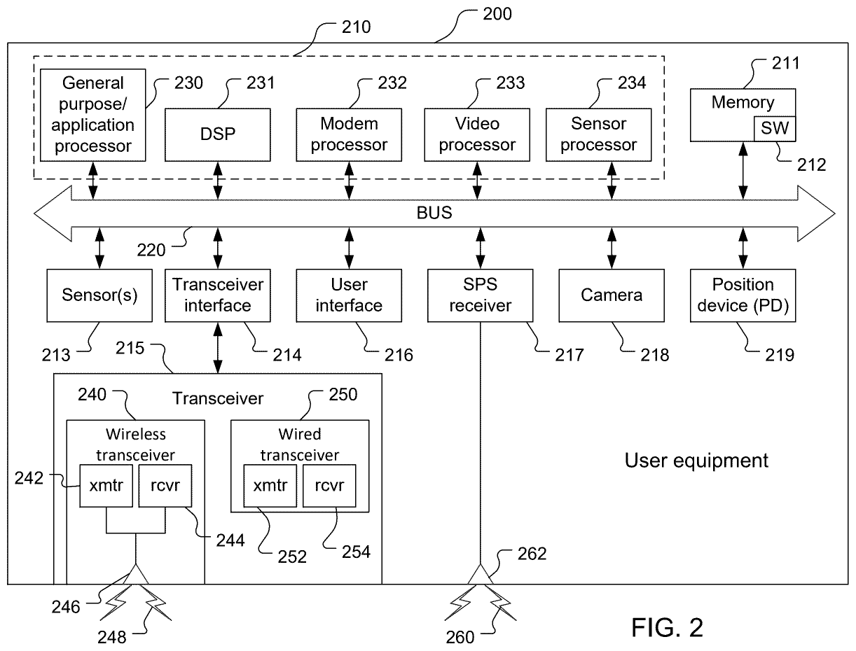

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory, processor-readable storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes instructions of software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to guided (e.g., wired electrical and/or optical) signals and from guided (e.g., wired electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The SPS receiver 217 (e.g., a Global Positioning System (GPS) receiver) may be capable of receiving and acquiring SPS signals 260, 261 via SPS antennas 262, 263. The SPS antennas 262, 263 are configured to transduce the SPS signals 260, 261 from wireless signals to guided signals, e.g., wired electrical or optical signals, and may be integrated with the antenna 246. The SPS receiver 217 may be configured to process, in whole or in part, the acquired SPS signals 260, 261 for estimating a location of the UE 200. For example, the SPS receiver 217 may be configured to determine location of the UE 200 by trilateration using the SPS signals 260, 261. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260, 261 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, 261, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

An apparatus such as a UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

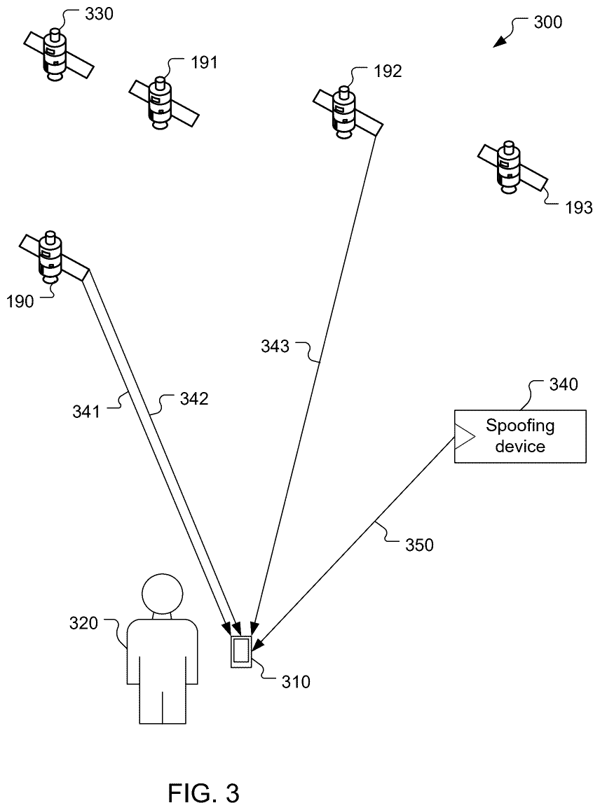

Referring also to FIG. 3, in a navigation environment 300, a UE 310 associated with (e.g., held by) a user 320 may receive satellite signals from the satellites 190-193 and one or more other satellites such as a satellite 330. The UE 310 may be an example of the UE 200 or the UE 105. The satellites 190-193 are members of a satellite constellation, i.e., a group of satellites that are part of a system, e.g., controlled by a common entity such as a government, and orbiting in complementary orbits to facilitate determining positions of entities around the world. The satellite 330 is a member of a different constellation than the constellation of which the satellites 190-193 are members. The satellites 190-193 may be, for example, members of the GPS, Galileo, Beidou, GLONASS, or QZSS constellation. The satellites 190-193 may each transmit multiple satellite signals in different frequency bands, e.g., the satellite 190 may transmit a satellite signal 341 and a satellite signal 342 that have frequencies in different frequency bands, e.g., L1 and L2/L5 frequency bands, the satellites 191 and 193 may transmit signals in the same frequency bands (not shown), and a satellite signal 343 from the satellite 192 may have a frequency in only one frequency band, e.g., the L1 frequency band.

The navigation environment 300 may include one or more spoofing devices, e.g., a spoofing device 340. The spoofing device 340 is configured to transmit one or more spoofing signals, e.g., a spoofing signal 350 configured to appear like a legitimate SPS signal, e.g., including a pseudorandom number code of a signal from one of the satellites 190-193, 330. The spoofing signal 350, however, typically originates from a different direction relative to the UE 310, than the satellite whose signal the spoofing signal 350 spoofs. The UE 310 may determine an incorrect location of the UE 310 if the UE 310 uses the spoofing signal 350 to determine the location of the UE 310, and thus it is desirable to avoid using a spoofed signal to determine a location of a mobile device.

GNSS spoofing is a technique used to deceive positioning signal receivers (e.g., SPS signal receivers) by broadcasting incorrect positioning signals. Spoofing is the process of creating fake positioning signals to trick a positioning signal receiver into determining incorrect positioning information (e.g., pseudorange, location, velocity, etc.), which can have serious consequences in various applications such as navigation, military operations, and autonomous navigation (e.g., driving) systems. Signals may be spoofed for a variety of reasons, e.g., malicious reasons, or to (mis)direct someone to a desired location (e.g., a business). With the advancement of spoofing technology, it is increasingly difficult to guarantee positioning signal integrity during calibration, especially in vital applications such as autonomous vehicles, defense, and aviation. Autonomous systems prioritize safety, and redundancy is frequently incorporated to prevent disastrous consequences from arising from a single point of failure, like an SPS. Maintaining safety may depend on making sure redundant systems, such as multiple SPS receivers or alternative positioning systems, are properly calibrated and synchronized. To help guarantee that all positioning systems deliver consistent data, autonomous systems usually go through extensive testing and calibration procedures.

For safe and precise navigation in general-purpose usage, and in autonomous systems like self-driving cars, drones, and robotic platforms, using accurate and authentic positioning data (e.g., SV ID, SPS signal measurement(s)) validation is essential. For real-time decision-making, autonomous systems frequently integrate SPS location data with information from other sensors, but these methods may not be secure enough to avoid misleading an autonomous vehicle based on data due to a spoofed signal. Techniques discussed herein may help counter positioning signal spoofing more accurately and/or more reliably than previous techniques.

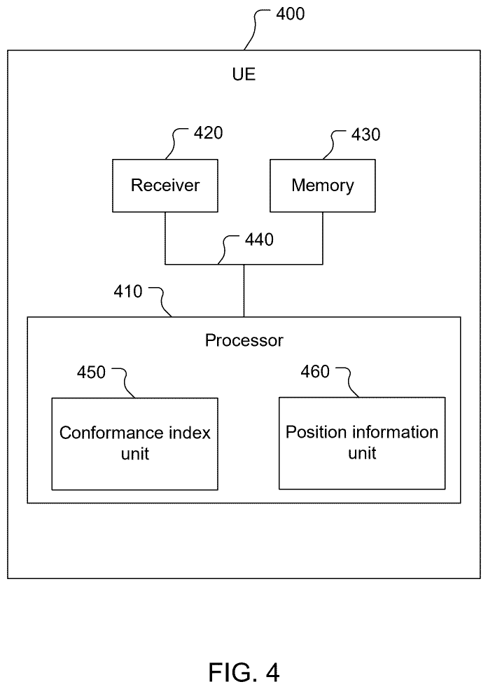

Referring to FIG. 4, with further reference to FIGS. 1-3, a UE 400 includes a processor 410, a receiver 420, and a memory 430 communicatively coupled to each other by a bus 440. The UE 400 may include some or all of the components shown in FIG. 4, and may include one or more other components such as any of those shown in FIG. 2 such that the UE 200 may be an example of the UE 400. Even if referred to in the singular, the processor 410 may include one or more processors, the receiver 420 may include one or more transceivers (e.g., one or more transmitters and/or one or more receivers), and/or the memory 430 may include one or more memories. The processor 410 may include one or more components of the processor 210. The receiver 420 may include one or more of the components of the transceiver 215, e.g., the wireless receiver 244 and the antenna 246. Also, the receiver 420 may include the wired receiver 254. The receiver 420 may include the SPS receiver 217 and the antenna 262. The memory 430 may be configured similarly to the memory 211, e.g., including software with processor-readable instructions configured to cause the processor 410 to perform functions.

The description herein may refer only to the processor 410 performing a function, but this includes other implementations such as where the processor 410 executes software (stored in the memory 430) and/or firmware. The description herein may refer to the UE 400 performing a function as shorthand for one or more appropriate components (e.g., the processor 410 and the memory 430) of the UE 400 performing the function. The processor 410 (possibly in conjunction with the memory 430 and, as appropriate, the receiver 420) may include a conformance index unit 450 and a position information unit 460. The conformance index unit 450 may be configured to perform one or more functions to determine and store conformance indexes. The position information unit 460 may be configured to use present and past conformance indexes to determine position information such as one or more ranges, one or more pseudoranges, one or more location estimates, one or more speeds, one or more velocities, etc. of the UE 400. The conformance index unit 450 and the position information unit 460 are discussed further below, and the description may refer to the processor 410 generally, or the UE 400 generally, as performing any of the functions of the conformance index unit 450 and/or the position information unit 460, with the UE 400 being configured to perform the function(s). While the discussion herein focuses on the UE 400, functions discussed as being performed by the UE 400 may also or alternatively be performed by another apparatus (e.g., a base station).

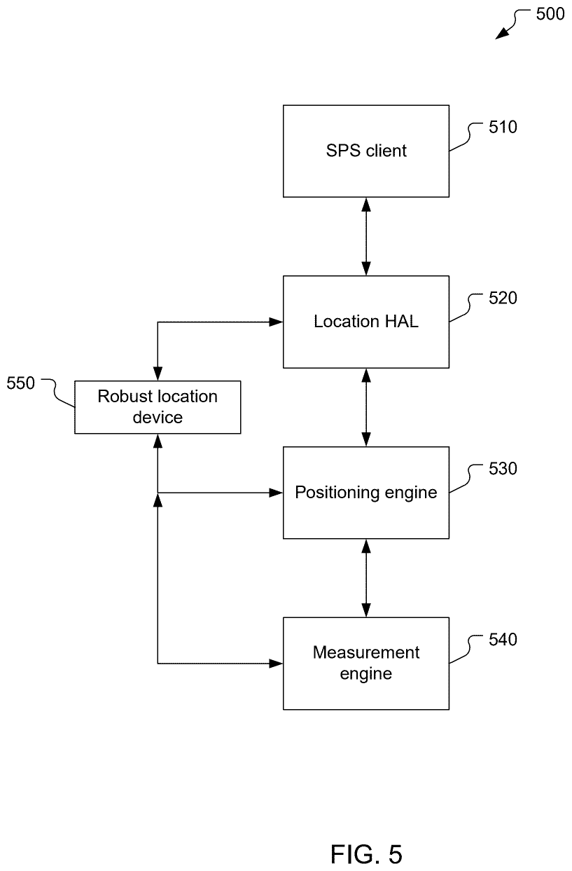

Referring also to FIG. 5, a portion 500 of the UE 400 includes an SPS client 510, a location HAL 520 (Hardware Abstraction Layer), a positioning engine 530, a measurement engine 540, and a robust location device 550 communicatively coupled for bi-directional communication as shown. The location HAL 520, the positioning engine 530, the measurement engine 540, and the robust location device 550 may be implemented by a modem (e.g., part of the receiver 420 or part of a transceiver including the receiver 420) that includes a processor (e.g., a portion of the processor 410 or one or more processors of multiple processors comprising the processor 410). The measurement engine 540, e.g., the SPS receiver 217, may receive and measure SPS signals. The positioning engine 530 (e.g., part of the SPS receiver 217 and/or the position information unit 460) may use the measurements of the SPS signals provided by the measurement engine 540 to determine position fixes for the UE 400. The location HAL 520 (Hardware Abstraction Layer that is a software component that acts as an interface between hardware and the operation system). The location HAL 520 can provide position information (also called location information), e.g., position fixes, to the SPS client 510, e.g., an application of the UE 400 that uses location information, such as a navigation application, a shopping application, a social media application, etc.

The robust location device (RLD) 550, e.g., the conformance index unit 450, is configured to determine a conformity index (CI) as an indication of how well inputs conform to expectations, e.g., nominal expectations. For example, the RLD 550 may consider position fixes obtained using one or more positioning techniques and/or one or more positioning technologies, and determine a conformity index value based on how well the different position fixes match. The RLD 550 may, for example, consider a number of valid position fixes determined, the SPS constellation(s)/frequency(ies) used, any supporting technique(s)/technology(ies) used (e.g., cellular positioning), one or more environmental factors, user-specific detail(s) (e.g., motion consistency), and/or history (e.g., initialize the CI at a value that is higher than a default start value (e.g., 0.5) if there has been a recent hot start and initialize at the default start value otherwise). The conformity index may, for example, have a value between zero (0) and 0.99. A higher conformity index value indicates a higher conformance of the inputs to expectations. A conformity index value below 0.5 may be considered an indication that suspicious information is likely being used to determine the position fix. A low conformity index value, e.g., below 0.2, may be considered an indication that spoofed information is definitely being used to determine the position fix. If the conformity index value is above a threshold, e.g., 0.98, then the position information unit 460 may determine a composite position fix, e.g., an average or weighted average, of the multiple position fixes determined using different positioning techniques and/or technologies.

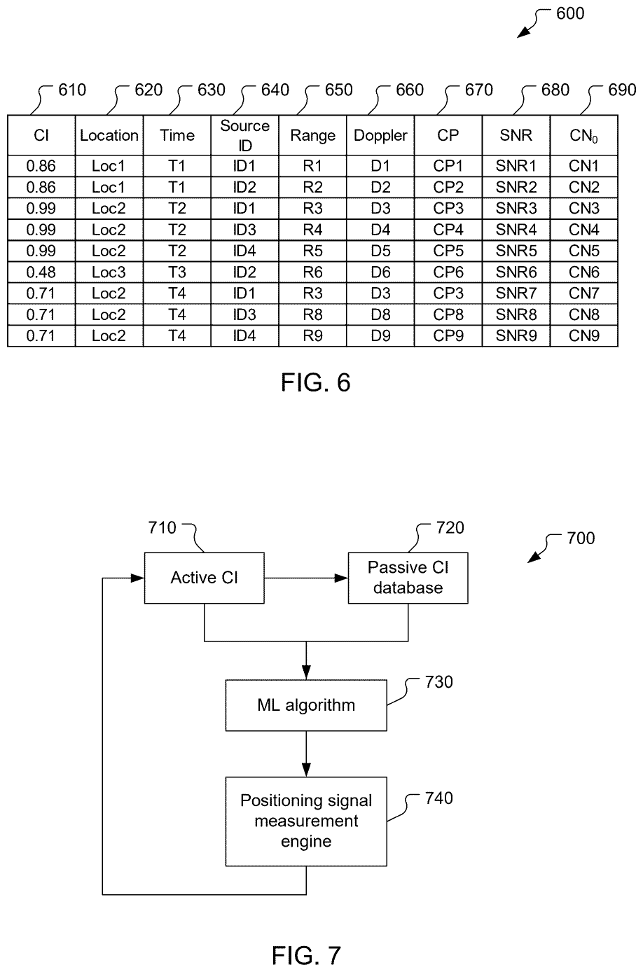

Referring also to FIG. 6, the conformance index unit 450 in combination with the position information unit 460 may store CI values and associated information in a CI database 600. The CI database 600 is an example, and other CI databases, e.g., with different information, may be used. In this example, the CI database 600 includes a CI index field 610, a location field 620, a time field 630, a positioning signal source identifier (e.g., a satellite number (SN)) field 640, a pseudorange (PR) field 650, a Doppler frequency shift (DO) field 660, a carrier phase frequency shift (CP) field 670, a signal-to-noise ratio (SNR) field 680, and a carrier-to-noise-density ratio (CN₀) 690. The values for location may have any of various granularities (e.g., points comprising latitude, longitude, and possibly altitude, or regions). The values for time may have any of a variety of granularities (e.g., day/month/year/hour/minute/second or day/month/year/hour (or range of hours, or range of minutes)). As shown, multiple entries may be provided for the same CI value, location, and time, corresponding to different signal sources (e.g., different SVs). Further, different CI values may be determined for the same location (here Loc2) at different times, using the same signal sources. In this example, assuming the SVs are in the same locations at times T1 and T2, the signals corresponding to sources ID3 and ID4 may be spoofed because the ranges R4, R5 at time T1 do not match the ranges R8, R9 at time T2.

Referring also to FIG. 7, a set 700 of components of the UE 400 for determining position information using CI values includes an active CI unit 710, a passive CI database 720, an ML algorithm 730 (Machine Learning algorithm), and a positioning signal measurement engine 740. The active CI unit 710 is configured to measure newly-received positioning signals and determine a corresponding CI value along with other parameters (e.g., values of the fields 620, 630, 640, 650, 660, 670, 680, 690, and/or predicted measurement error). The passive CI database 720 stores historical values for CI values and corresponding parameters, e.g., as shown in FIG. 6, with the database 600 being an example of the database 720. The ML algorithm 730 is configured to use the active CI value and corresponding parameters, and one or more corresponding CI values (e.g., corresponding to the same or similar location as the present location of the UE 400) and corresponding parameters to evaluate the validity of the newly-received positioning signals. The ML algorithm 730, as discussed further below, identifies position information (e.g., signal measurements and/or position fixes) that can and cannot be trusted. If there is a significant difference (more than a threshold) between the active CI value and the historical CI value(s), then the present positioning signal measurement(s) may be ignored or de-weighted. For example, if the historical CI value(s) is very low, but the UE 400 receives a strong signal, then the present signal may be determined to be spoofed. As another example, if the active CI is low, then the present signal(s) may be determined to be spoofed even if the historical CI is high. The ML algorithm 730 (e.g., an isolated forest algorithm) may perform data processing, abnormality detection, and deception attack confirmation. The positioning signal measurement engine 740 is configured to produce measurements for a positioning signal list provided in the ML algorithm 730. The positioning signal measurement engine 740 considers the genuine data marked by the ML algorithm 730 (based on the active CI and passive index) and provides the location information to a user.

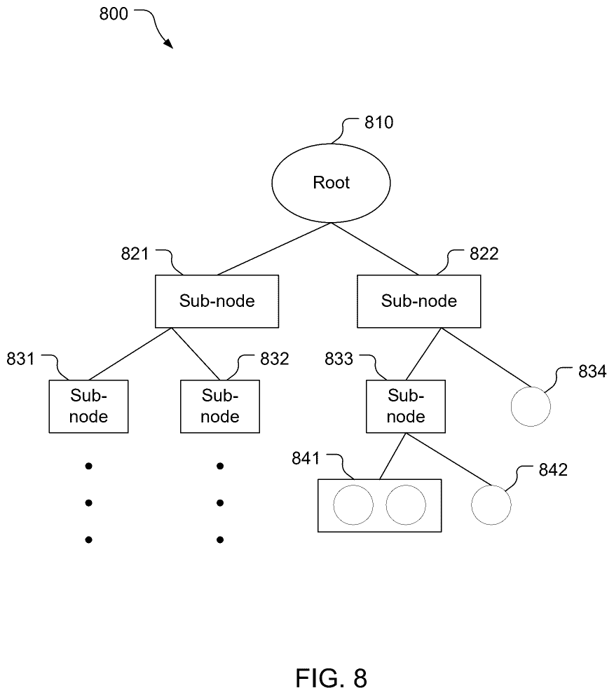

Referring also to FIG. 8, an isolation forest tree 800 is an example of an isolation forest tree produced by the ML algorithm 730. The ML algorithm 730 may analyze different subsets of data to produce different isolation trees. For example, the ML algorithm 730 may analyze different subsets of CI, positioning signal source ID (e.g., satellite number SVN), pseudorange (PR), Doppler frequency shift (DO, carrier phase frequency shift (CP), and signal-to-noise ratio (SNR). This is an example, and subsets of other data sets may be used. The ML algorithm 730 may select a number of trees to produce/analyze, and the sample size of each tree (which may be configurable, e.g., based on sample data received). The algorithm 730 may build each tree by selecting a respective subset of data, and recursively partitioning the data until each observation is isolated (including cases where a sub-node includes only observations of identical value), or a maximum depth (maximum quantity of layers) of the tree is reached. In the example shown, the tree 800 includes a root node 810, sub-nodes 821, 822 at a second layer of the tree 800, sub-nodes 831, 832, 833 and an isolated observation 834 at a third layer of the tree 800, and a sub-node 841 and an isolated observation 842 at a fourth layer of the tree 800. At each node or sub-node, a split value for a chosen parameter (of multiple parameters corresponding to the node) is selected and the observations of the sub-node split based on the split value. This continues until all the observations are isolated or a maximum tree depth is reached. In this example, the observation 834 is isolated before any other observation, and the observation 842 is the next-earliest isolated observation. The observations 834, 842 may be called leaf nodes. Path lengths from the root node 810 to the leaf nodes (e.g., the observations 834, 842) represent the number of splits used to isolate the observations, with anomalies expected to have shorter path lengths because anomalies are easier to isolate. The signal, or SVN corresponding to an isolated observation may be identified as an anomaly, e.g., being or corresponding to a spoofed signal. The algorithm 730 may quickly and inexpensively identify valid and spoofed signals, e.g., by using CI for a single SPS constellation and/or by using CI for SPS signals only, and not terrestrial-based positioning signals. Primarily, the algorithm 730 identifies spoofed signals using CI, but the algorithm 730 may identify anomalous signals using one or more other parameters, e.g., SNR, such that if the SNR of a signal is too strong, the signal may be identified as being spoofed. By using active and historic CI data, an anomalous observation may be determined for a positioning signal based on either the data corresponding to the active CI or the data corresponding to the historic CI causing an observation to be an outlier.

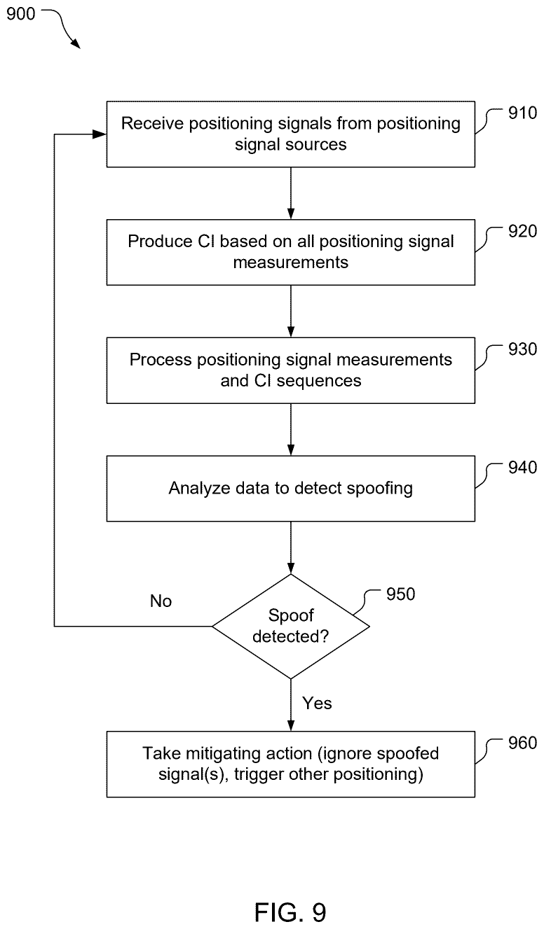

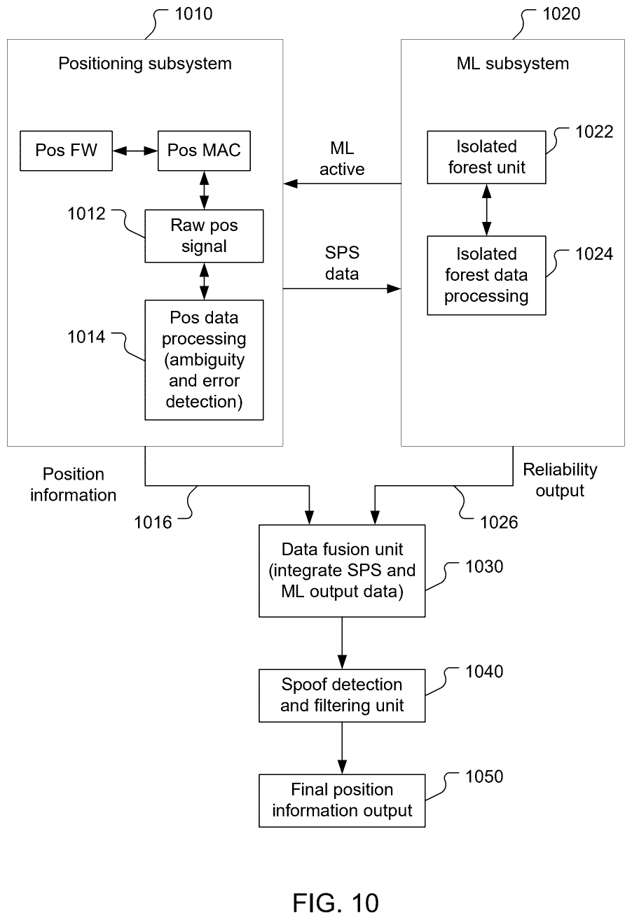

Referring also to FIG. 9 and FIG. 10, a spoofed positioning signal mitigation method 900, implemented by a positioning (pos) subsystem 1010, an ML subsystem 1020, and the position information unit 460 of the UE 400, includes the stages shown. The method 900 is an example, and other implementations of a positioning signal mitigation method may be used.

At stage 910, the UE 400 receives positioning signals 1012 from positioning signal sources. For example, the SPS receiver 217 may receive SPS signals. As another example, the receiver 420 may receive terrestrial-based (e.g., cellular) positioning signals (e.g., DL-PRS). The positioning signals 1012 are provided to the position information unit 460 for position data processing 1014 for measurement and output of position information 1016 (e.g., positioning signal measurements).

At stage 920, a conformity index is produced based on the measurements of the newly-received positioning signals. The newly-received positioning signals may include one or more spoofed signals, and thus the CI determined may be lower than a threshold level indicative of high conformance of positioning inputs.

At stage 930, the positioning signal measurements and CI sequences are processed. The conformance index unit 450 determines multiple CI values over time, e.g., every second, and the multiple CI values form a CI sequence. Multiple CI values may be combined (e.g., averaged) over a window of time to determine the active CI value. Multiple CI values may be evaluated (including several SPS parameters) and new CI values updated based on output of the ML algorithm 730.

At stage 940, the collected and processed data are analyzed to detect spoofing. For example, the algorithm 730 (e.g., an isolated forest unit 1022) produces one or more isolated forest trees and performs isolated forest data processing 1024 (e.g., traversing the tree(s)) to identify unreliable signals (e.g., spoofed signals). The algorithm 730 may provide a reliability output signal 1026 indicating which signal(s), if any, are unreliable (e.g., spoofed). The reliability output signal 1026 may identify only unreliable signals (e.g., being an explicit spoof data notification), or may identify only reliable signals (with this being an implicit indication of the unreliable signals), or both. The processor 410 may include a data fusion unit 1030 that is configured to associate position information (e.g., SPS data) and corresponding output data from the ML subsystem 1020.

At stage 950, the UE 400 determines whether any spoofed signal is detected. For example, a spoof detection and filtering unit 1040 may analyze the fused data from the data fusion unit to locate any anomaly indications. If no anomaly indication is found, then the method 900 may return to stage 910. If any anomaly indication is found, then the spoof detection and filtering unit 1040 may identify the corresponding positioning signal and the method 900 proceeds to stage 960.

At stage 960, one or more mitigating actions are taken. For example, the spoof detection and filtering unit 1040 may discard or otherwise cause the identified anomalous signal(s) to be ignored (not used to determine a final position fix), or at least de-weighted, in a determination of a final position fix 1050 output by the position information unit 460. Also or alternatively, one or more other mitigating actions may be triggered, such as providing a warning to a user of the UE 400 and/or to an application using a position fix of the UE 400 that a position fix of the UE 400 is unreliable.

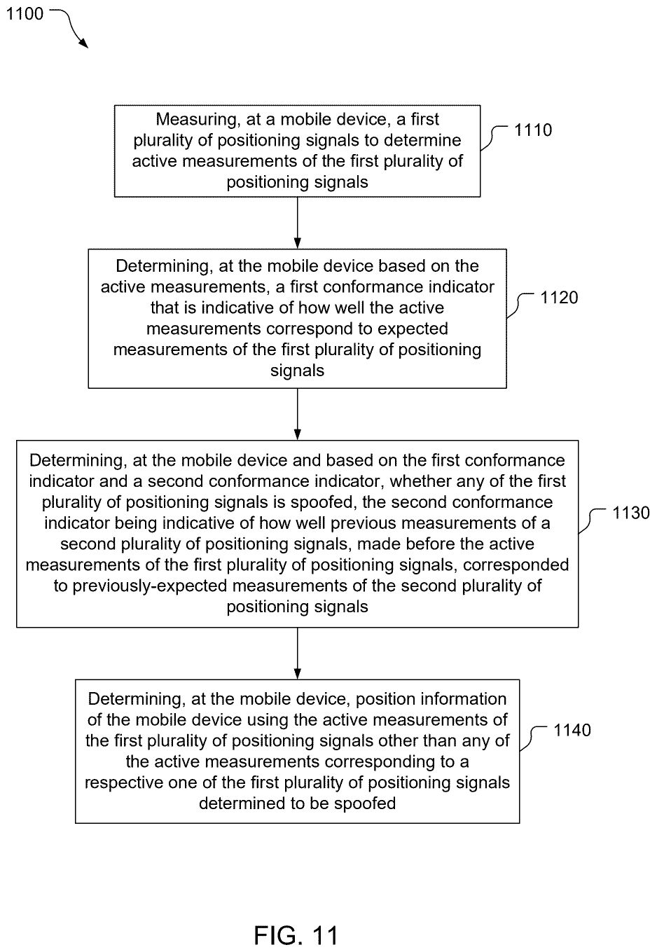

Referring to FIG. 11, with further reference to FIGS. 1-10, a method 1100 of processing positioning signals includes the stages shown. The method 1100 is, however, an example only and not limiting. The method 1100 may be altered, e.g., by having stages added, removed, rearranged, combined, performed concurrently, and/or having single stages split into multiple stages.

At stage 1110, the method 1100 includes measuring, at a mobile device, a first plurality of positioning signals to determine active measurements of the first plurality of positioning signals. For example, at stage 910, the position information unit 460 receives, via the receiver 420, and measures first positioning signals (e.g., first SV signals). The processor 410, possibly in combination with the memory 430, in combination with the receiver 420 comprise means for measuring the first plurality of positioning signals.

At stage 1120, the method 1100 includes determining, at the mobile device based on the active measurements, a first conformance indicator that is indicative of how well the active measurements correspond to expected measurements of the first plurality of positioning signals. For example, the conformance index unit 450 uses the measurements of the first positioning signals to determine a first conformity index value. The processor 410, possibly in combination with the memory 430, comprise means for determining the first conformance indicator.

At stage 1130, the method 1100 includes determining, at the mobile device and based on the first conformance indicator and a second conformance indicator, whether any of the first plurality of positioning signals is spoofed, the second conformance indicator being indicative of how well previous measurements of a second plurality of positioning signals, made before the active measurements of the first plurality of positioning signals, corresponded to previously-expected measurements of the second plurality of positioning signals. For example, the ML algorithm 730 uses the CI database 720 (e.g., corresponding to the same signals as, and/or at least some different signals from, the first plurality of positioning signals) to produce and analyze one or more isolation forest trees to determine, based on the first and second conformance indicators (corresponding to present and historical CI values), whether there is a spoofed signal whose measurement is used for determining a position fix of the UE 400. The processor 410, possibly in combination with the memory 430, comprise means for determining whether any of the first plurality of positioning signals is spoofed.

At stage 1140, the method 1100 includes determining, at the mobile device, position information of the mobile device using the active measurements of the first plurality of positioning signals other than any of the active measurements corresponding to a respective one of the first plurality of positioning signals determined to be spoofed. For example, the position information unit 460 may ignore, at stage 960, any measurement of a spoofed signal to determine the final position fix 1050 for the UE 400.

Implementations of the method 1100 may include one or more of the following features. In an example implementation, determining whether any of the first plurality of positioning signals is spoofed comprises using the first conformance indicator and the second conformance indicator as inputs to a machine-learning algorithm. For example, the ML algorithm 730 uses at least some data from the active CI unit 710 and at least some data from the passive CI database 720 as inputs. In a further example implementation, determining whether any of the first plurality of positioning signals is spoofed further comprises using, as input to the machine-learning algorithm, at least one of positioning signal source identity, pseudorange, Doppler frequency shift, carrier phase frequency shift, and signal-to-noise ratio corresponding to at least one of the first plurality of positioning signals. In another further example implementation, the machine-learning algorithm is an isolated forest algorithm with each terminal node indicating whether a respective one of the first plurality of positioning signals is anomalous. For example, each leaf node of the tree 800 indicates whether the corresponding signal is anomalous (e.g., depending on a level of the tree at which the terminal node is disposed).

Also or alternatively, implementations of the method 1100 may include one or more of the following features. In an example implementation, the first plurality of positioning signals correspond to satellite vehicles from a single SPS constellation. In another example implementation, determining the first conformance indicator is based on at least one of a quantity of position fixes obtained, a satellite positioning system constellation corresponding to at least some of the first plurality of positioning signals, a frequency of at least some of the first plurality of positioning signals, at least one environmental factor, motion consistency, and a timing since a most recent start of the mobile device and a type of the most recent start.

### Implementation Examples

Implementation examples are provided in the following numbered clauses.

Clause 1. A method of processing positioning signals, the method comprising:
measuring, at a mobile device, a first plurality of positioning signals to determine active measurements of the first plurality of positioning signals;
determining, at the mobile device based on the active measurements, a first conformance indicator that is indicative of how well the active measurements correspond to expected measurements of the first plurality of positioning signals;
determining, at the mobile device and based on the first conformance indicator and a second conformance indicator, whether any of the first plurality of positioning signals is spoofed, the second conformance indicator being indicative of how well previous measurements of a second plurality of positioning signals, made before the active measurements of the first plurality of positioning signals, corresponded to previously-expected measurements of the second plurality of positioning signals; and
determining, at the mobile device, position information of the mobile device using the active measurements of the first plurality of positioning signals other than any of the active measurements corresponding to a respective one of the first plurality of positioning signals determined to be spoofed.

Clause 2. The method of clause 1, wherein determining whether any of the first plurality of positioning signals is spoofed comprises using the first conformance indicator and the second conformance indicator as inputs to a machine-learning algorithm.

Clause 3. The method of clause 2, wherein determining whether any of the first plurality of positioning signals is spoofed further comprises using, as input to the machine-learning algorithm, at least one of positioning signal source identity, pseudorange, Doppler frequency shift, carrier phase frequency shift, and signal-to-noise ratio corresponding to at least one of the first plurality of positioning signals.

Clause 4. The method of clause 2, wherein the machine-learning algorithm is an isolated forest algorithm with each terminal node indicating whether a respective one of the first plurality of positioning signals is anomalous.

Clause 5. The method of clause 1, wherein the first plurality of positioning signals correspond to satellite vehicles from a single SPS constellation.

Clause 6. The method of clause 1, wherein determining the first conformance indicator is based on at least one of a quantity of position fixes obtained, a satellite positioning system constellation corresponding to at least some of the first plurality of positioning signals, a frequency of at least some of the first plurality of positioning signals, at least one environmental factor, motion consistency, and a timing since a most recent start of the mobile device and a type of the most recent start.

Clause 7. A mobile device comprising:
at least one receiver configured to receive a first plurality of positioning signals and a second plurality of positioning signals;
at least one memory; and
at least one processor communicatively coupled to the at least one receiver and the at least one memory and configured to:
   measure the first plurality of positioning signals to determine active measurements of the first plurality of positioning signals;
   determine, based on the active measurements, a first conformance indicator that is indicative of how well the active measurements correspond to expected measurements of the first plurality of positioning signals;
   determine, based on the first conformance indicator and a second conformance indicator, whether any of the first plurality of positioning signals is spoofed, the second conformance indicator being indicative of how well previous measurements of the second plurality of positioning signals, made before the active measurements of the first plurality of positioning signals, corresponded to previously-expected measurements of the second plurality of positioning signals; and
   determine position information of the mobile device using the active measurements of the first plurality of positioning signals other than any of the active measurements corresponding to a respective one of the first plurality of positioning signals determined to be spoofed.

Clause 8. The mobile device of clause 7, wherein to determine whether any of the first plurality of positioning signals is spoofed the at least one processor is configured to use the first conformance indicator and the second conformance indicator as inputs to a machine-learning algorithm.

Clause 9. The mobile device of clause 8, wherein to determine whether any of the first plurality of positioning signals is spoofed the at least one processor is further configured to use, as input to the machine-learning algorithm, at least one of positioning signal source identity, pseudorange, Doppler frequency shift, carrier phase frequency shift, and signal-to-noise ratio corresponding to at least one of the first plurality of positioning signals.

Clause 10. The mobile device of clause 8, wherein the machine-learning algorithm is an isolated forest algorithm with each terminal node indicating whether a respective one of the first plurality of positioning signals is anomalous.

Clause 11. The mobile device of clause 7, wherein the first plurality of positioning signals correspond to satellite vehicles from a single SPS constellation.

Clause 12. The mobile device of clause 7, wherein the at least one processor is configured to determine the first conformance indicator based on at least one of a quantity of position fixes obtained, a satellite positioning system constellation corresponding to at least some of the first plurality of positioning signals, a frequency of at least some of the first plurality of positioning signals, at least one environmental factor, motion consistency, and a timing since a most recent start of the mobile device and a type of the most recent start.

Clause 13. A mobile device comprising:
means for measuring a first plurality of positioning signals to determine active measurements of the first plurality of positioning signals;
means for determining, based on the active measurements, a first conformance indicator that is indicative of how well the active measurements correspond to expected measurements of the first plurality of positioning signals;
means for determining, based on the first conformance indicator and a second conformance indicator, whether any of the first plurality of positioning signals is spoofed, the second conformance indicator being indicative of how well previous measurements of a second plurality of positioning signals, made before the active measurements of the first plurality of positioning signals, corresponded to previously-expected measurements of the second plurality of positioning signals; and
means for determining position information of the mobile device using the active measurements of the first plurality of positioning signals other than any of the active measurements corresponding to a respective one of the first plurality of positioning signals determined to be spoofed.

Clause 14. The mobile device of clause 13, wherein the means for determining whether any of the first plurality of positioning signals is spoofed comprise means for using the first conformance indicator and the second conformance indicator as inputs to a machine-learning algorithm.

Clause 15. The mobile device of clause 14, wherein the means for determining whether any of the first plurality of positioning signals is spoofed further comprise means for using, as input to the machine-learning algorithm, at least one of positioning signal source identity, pseudorange, Doppler frequency shift, carrier phase frequency shift, and signal-to-noise ratio corresponding to at least one of the first plurality of positioning signals.

Clause 16. The mobile device of clause 14, wherein the machine-learning algorithm is an isolated forest algorithm with each terminal node indicating whether a respective one of the first plurality of positioning signals is anomalous.

Clause 17. The mobile device of clause 13, wherein the first plurality of positioning signals correspond to satellite vehicles from a single SPS constellation.

Clause 18. The mobile device of clause 13, wherein the means for determining the first conformance indicator comprise means for determining the first conformance indicator based on at least one of a quantity of position fixes obtained, a satellite positioning system constellation corresponding to at least some of the first plurality of positioning signals, a frequency of at least some of the first plurality of positioning signals, at least one environmental factor, motion consistency, and a timing since a most recent start of the mobile device and a type of the most recent start.

Clause 19. A non-transitory, processor-readable storage medium comprising processor-readable instructions to cause at least one processor of a mobile device, processing positioning signals, to:
measure a first plurality of positioning signals to determine active measurements of the first plurality of positioning signals;
determine, based on the active measurements, a first conformance indicator that is indicative of how well the active measurements correspond to expected measurements of the first plurality of positioning signals;
determine, based on the first conformance indicator and a second conformance indicator, whether any of the first plurality of positioning signals is spoofed, the second conformance indicator being indicative of how well previous measurements of a second plurality of positioning signals, made before the active measurements of the first plurality of positioning signals, corresponded to previously-expected measurements of the second plurality of positioning signals; and
determine position information of the mobile device using the active measurements of the first plurality of positioning signals other than any of the active measurements corresponding to a respective one of the first plurality of positioning signals determined to be spoofed.

Clause 20. The non-transitory, processor-readable storage medium of clause 19, wherein the processor-readable instructions to cause the at least one processor to determine whether any of the first plurality of positioning signals is spoofed comprise processor-readable instructions to cause the at least one processor to use the first conformance indicator and the second conformance indicator as inputs to a machine-learning algorithm.

Clause 21. The non-transitory, processor-readable storage medium of clause 20, wherein the processor-readable instructions to cause the at least one processor to determine whether any of the first plurality of positioning signals is spoofed further comprise processor-readable instructions to cause the at least one processor to use, as input to the machine-learning algorithm, at least one of positioning signal source identity, pseudorange, Doppler frequency shift, carrier phase frequency shift, and signal-to-noise ratio corresponding to at least one of the first plurality of positioning signals.

Clause 22. The non-transitory, processor-readable storage medium of clause 20, wherein the machine-learning algorithm is an isolated forest algorithm with each terminal node indicating whether a respective one of the first plurality of positioning signals is anomalous.

Clause 23. The non-transitory, processor-readable storage medium of clause 19, wherein the first plurality of positioning signals correspond to satellite vehicles from a single SPS constellation.

Clause 24. The non-transitory, processor-readable storage medium of clause 19, wherein the processor-readable instructions to cause the at least one processor to determine the first conformance indicator comprise processor-readable instructions to cause the at least one processor to determine the first conformance indicator based on at least one of a quantity of position fixes obtained, a satellite positioning system constellation corresponding to at least some of the first plurality of positioning signals, a frequency of at least some of the first plurality of positioning signals, at least one environmental factor, motion consistency, and a timing since a most recent start of the mobile device and a type of the most recent start.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. Further, well-known circuits, processes, algorithms, structures, and/or techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20%, ±10%, ±5%, and ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20%, ±10%, ±5%, and ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method of processing positioning signals, the method comprising:
measuring, at a mobile device, a first plurality of positioning signals to determine active measurements of the first plurality of positioning signals;
determining, at the mobile device based on the active measurements, a first conformance indicator that is indicative of how well the active measurements correspond to expected measurements of the first plurality of positioning signals;
determining, at the mobile device and based on the first conformance indicator and a second conformance indicator, whether any of the first plurality of positioning signals is spoofed, the second conformance indicator being indicative of how well previous measurements of a second plurality of positioning signals, made before the active measurements of the first plurality of positioning signals, corresponded to previously-expected measurements of the second plurality of positioning signals; and
determining, at the mobile device, position information of the mobile device using the active measurements of the first plurality of positioning signals other than any of the active measurements corresponding to a respective one of the first plurality of positioning signals determined to be spoofed.

2. The method of claim 1, wherein determining whether any of the first plurality of positioning signals is spoofed comprises using the first conformance indicator and the second conformance indicator as inputs to a machine-learning algorithm.

3. The method of claim 2, wherein determining whether any of the first plurality of positioning signals is spoofed further comprises using, as input to the machine-learning algorithm, at least one of positioning signal source identity, pseudorange, Doppler frequency shift, carrier phase frequency shift, and signal-to-noise ratio corresponding to at least one of the first plurality of positioning signals.

4. The method of claim 2, wherein the machine-learning algorithm is an isolated forest algorithm with each terminal node indicating whether a respective one of the first plurality of positioning signals is anomalous.

5. The method of claim 1, wherein the first plurality of positioning signals correspond to satellite vehicles from a single SPS constellation.

6. The method of claim 1, wherein determining the first conformance indicator is based on at least one of a quantity of position fixes obtained, a satellite positioning system constellation corresponding to at least some of the first plurality of positioning signals, a frequency of at least some of the first plurality of positioning signals, at least one environmental factor, motion consistency, and a timing since a most recent start of the mobile device and a type of the most recent start.

7. A mobile device comprising:
at least one receiver configured to receive a first plurality of positioning signals and a second plurality of positioning signals;
at least one memory; and
at least one processor communicatively coupled to the at least one receiver and the at least one memory and configured to:
measure the first plurality of positioning signals to determine active measurements of the first plurality of positioning signals;
determine, based on the active measurements, a first conformance indicator that is indicative of how well the active measurements correspond to expected measurements of the first plurality of positioning signals;
determine, based on the first conformance indicator and a second conformance indicator, whether any of the first plurality of positioning signals is spoofed, the second conformance indicator being indicative of how well previous measurements of the second plurality of positioning signals, made before the active measurements of the first plurality of positioning signals, corresponded to previously-expected measurements of the second plurality of positioning signals; and
determine position information of the mobile device using the active measurements of the first plurality of positioning signals other than any of the active measurements corresponding to a respective one of the first plurality of positioning signals determined to be spoofed.

8. The mobile device of claim 7, wherein to determine whether any of the first plurality of positioning signals is spoofed the at least one processor is configured to use the first conformance indicator and the second conformance indicator as inputs to a machine-learning algorithm.

9. The mobile device of claim 8, wherein to determine whether any of the first plurality of positioning signals is spoofed the at least one processor is further configured to use, as input to the machine-learning algorithm, at least one of positioning signal source identity, pseudorange, Doppler frequency shift, carrier phase frequency shift, and signal-to-noise ratio corresponding to at least one of the first plurality of positioning signals.

10. The mobile device of claim 8, wherein the machine-learning algorithm is an isolated forest algorithm with each terminal node indicating whether a respective one of the first plurality of positioning signals is anomalous.

11. The mobile device of claim 7, wherein the first plurality of positioning signals correspond to satellite vehicles from a single SPS constellation.

12. The mobile device of claim 7, wherein the at least one processor is configured to determine the first conformance indicator based on at least one of a quantity of position fixes obtained, a satellite positioning system constellation corresponding to at least some of the first plurality of positioning signals, a frequency of at least some of the first plurality of positioning signals, at least one environmental factor, motion consistency, and a timing since a most recent start of the mobile device and a type of the most recent start.

13. A mobile device comprising:
means for measuring a first plurality of positioning signals to determine active measurements of the first plurality of positioning signals;
means for determining, based on the active measurements, a first conformance indicator that is indicative of how well the active measurements correspond to expected measurements of the first plurality of positioning signals;
means for determining, based on the first conformance indicator and a second conformance indicator, whether any of the first plurality of positioning signals is spoofed, the second conformance indicator being indicative of how well previous measurements of a second plurality of positioning signals, made before the active measurements of the first plurality of positioning signals, corresponded to previously-expected measurements of the second plurality of positioning signals; and
means for determining position information of the mobile device using the active measurements of the first plurality of positioning signals other than any of the active measurements corresponding to a respective one of the first plurality of positioning signals determined to be spoofed.

14. The mobile device of claim 13, wherein the means for determining whether any of the first plurality of positioning signals is spoofed comprise means for using the first conformance indicator and the second conformance indicator as inputs to a machine-learning algorithm.

15. The mobile device of claim 14, wherein the means for determining whether any of the first plurality of positioning signals is spoofed further comprise means for using, as input to the machine-learning algorithm, at least one of positioning signal source identity, pseudorange, Doppler frequency shift, carrier phase frequency shift, and signal-to-noise ratio corresponding to at least one of the first plurality of positioning signals.

16. The mobile device of claim 14, wherein the machine-learning algorithm is an isolated forest algorithm with each terminal node indicating whether a respective one of the first plurality of positioning signals is anomalous.

17. The mobile device of claim 13, wherein the first plurality of positioning signals correspond to satellite vehicles from a single SPS constellation.

18. The mobile device of claim 13, wherein the means for determining the first conformance indicator comprise means for determining the first conformance indicator based on at least one of a quantity of position fixes obtained, a satellite positioning system constellation corresponding to at least some of the first plurality of positioning signals, a frequency of at least some of the first plurality of positioning signals, at least one environmental factor, motion consistency, and a timing since a most recent start of the mobile device and a type of the most recent start.
